(19) United States
(12) Patent Application Publication
(10) Pub. No.: US 2011/0161350 A1
(43) Pub. Date: Jun. 30, 2011

(54) APPLICATION SERVER AND METHOD FOR COLLECTING MACHINE DATA

(75) Inventors: Chi-Chih Wang, Tu-Cheng (TW); Rui-Jun Wang, Shenzhen City (CN); Xu-Kun Wang, Shenzhen City (CN); Jian-Feng Tang, Shenzhen City (CN)

(73) Assignees: GDS SOFTWARE (SHENZHEN) CO.,LTD, ShenZhen City (CN); HON HAI PRECISION INDUSTRY CO., LTD., Tu-Cheng (TW)

(21) Appl. No.: 12/826,619

(22) Filed: Jun. 29, 2010

(30) Foreign Application Priority Data
Dec. 29, 2009 (CN) 200910312500.8

(51) Int. Cl. G06F 17/30

(52) U.S. Cl. 707/769; 707/E17.014

(57) ABSTRACT

An application server and method collects and stores machine data from one or more machines. The application server sends a data acquisition command to a sensor of the searched machine to acquire the machine data of the searched machine, in response to a determination that the machine has been found according to a search command. The application server updates the machine data file with the acquired machine data, and transfers the updated machine data file to a database system.

### BACKGROUND

1. Technical Field

Embodiments of the present disclosure relate to data processing technology, and particularly to an application server and method for collecting data.

2. Description of Related Art

Generally, in a manufacturing enterprise, a large amount of data are generated and needed to be collected into a database. However, it is inconvenient and inefficient for people to collect the large amount of data manually. Moreover, if people update the database frequently, the database may be busy and difficult to access.

### BRIEF DESCRIPTION OF THE DRAWINGS

FIG. 1 is a systematic diagram of one embodiment of a data collection system;

FIG. 2 is a block diagram of one embodiment of an application server of FIG. 1; and

FIG. 3 is a flowchart of one embodiment of a method for collecting machine data.

### DETAILED DESCRIPTION

All of the processes described below may be embodied in, and fully automated via, function modules executed by one or more general purpose processors of a computer. Some or all of the methods may alternatively be embodied in specialized hardware. The function modules may be stored in any type of computer-readable medium or other computer storage device.

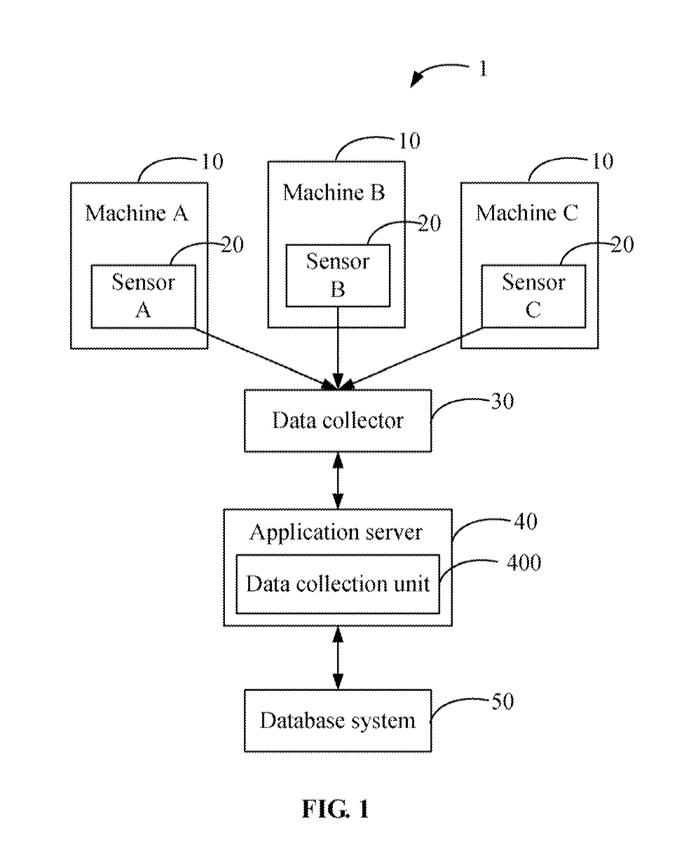

As used herein, the term, “machine data” may be defined as data generated by one or more machines of an assembly line. Likewise, the term, “sensor” may be defined as a device for collecting the machine data from the one or more machines. It may be understood that the term, “data” may refer to a single data item or may refer to a plurality of data items. These terms, with reference to the FIGS. 1-3, will be described in greater detail below.

FIG. 1 is a systematic diagram of one embodiment of a data collection system 1. The data collection system 1 includes one or more machines 10, a data collector 30, an application server 40, and a database system 50. The data collection system 1 may automatically acquire the machine data from the machines 10 and store the machine data into the database system 50.

In one embodiment, the machine 10 includes at least one sensor 20 to collect machine data of the machine 10. The sensor 20 may be, but is not limited to, an infrared sensor, a data acquiring sensor, and a microwave sensor. For example, the machine A includes the sensor A, and the machine B includes the sensor B. The machine 10 manufactures products, such as, motherboards and graphic cards. In one embodiment, the machine data include a power consumption of the machines 10, a number of products manufactured by the machine 10, a status of the machine 10 (e.g., a power-on status, or a power-off status), and a utilization rate of the machines 10. For example, as shown in FIG. 1, the sensor A acquires the power consumption of the machine A, the number of products produced by the machine A, the status of the machine A, and the utilization rate of the machine A. The data collector 30 connects to the one or more sensors 20 by a wireless connection (e.g., Wireless LAN) so as to collect the machine data from the one or more sensors 20. The data collector 30 also connects to the application server 40 to send the collected machine data to the application server 40.

The application server 40 electronically connects to a database system 50 using database connectivity, such as open database connectivity (ODBC) or java database connectivity (JDBC). In one embodiment, the application server 40 may be a personal computer (PC), a network server, or any other data-processing equipment. The database system 50 may store the machine data as mentioned above.

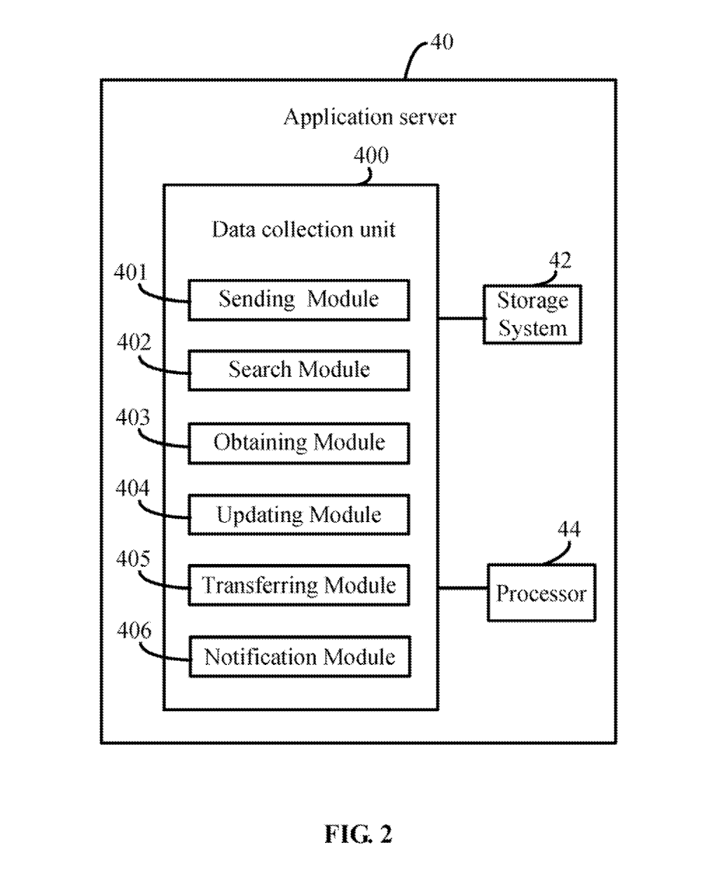

FIG. 2 is a block diagram of one embodiment of the application server 40 including a data collection unit 400. The data collection unit 400 automatically collects the machine data and processes the machine data. In one embodiment, the data collection unit 400 includes a sending module 401, a search module 402, an obtaining module 403, an updating module 404, a transferring module 405, and a notification module 406. One or more computerized codes of the modules 401-406 are stored in a storage system 42 of the application server 40. The storage system 42 also stores a machine data file. The machine data file is related to the one or more machines 10 and is used to store the machine data of the one or more machines 10. The machine data file may be, but is not limited to, a TXT file, a WORD file or an EXCEL file. One or more general purpose or specialized processors, such as a processor 44, executes the computerized codes of the modules 401-406 to provide one or more operations of the data collection unit 400.

The sending module 401 sends a connection command to electronically connect the application server 40 to the data collector 30. In one embodiment, the application server 30 establishes a communication connection with the data collector 30 using the connection command.

The search module 402 determines if the application server 40 has been electronically connected to the data collector 30. In one embodiment, the data collector 30 sends an acknowledgement message to the application server 40 when the connection command is received. If the application server 40 receives the acknowledgement message, the application server 40 establishes a communication connection with the data collector 30. In the exemplary embodiment, the acknowledgement message may be, but is not limited to, a character string, such as, “1122211.”

The search module 402 further sends a search command to the data collector 30 to search one of the machines 10 in response to a determination that the application server 40 has been connected to the data collector 30. In one embodiment, the search command includes a machine name, and the machine name is used to search a specific machine 10 (e.g., the machine A).

The obtaining module 403 further determines if the machine 10 has been found according to the search command. In one embodiment, if the machine (e.g., machine A) has been found according to the search command, the searched machine 10 automatically sends a feedback message to the data collector 30. In one exemplary embodiment, the feedback message may be, but is not limited to, a character string, such as, “OK.”

The obtaining module 403 further sends a data acquisition command to the sensor 10 to acquire machine data of the searched machine 10, in response to a determination that the machine 10 has been found. As mentioned above, the sensor 10 acquires the machine data of the corresponding machine 10. For example, the obtaining module 403 sends the data acquisition command to the sensor A, and the sensor A acquires the machine data of the machine A.

The updating module 404 determines if the acquired machine data is different from the machine data file stored in the storage system 42 of the application server 40. For example, if the obtaining module 403 acquires the machine data of the searched machine 10 at 9:00 A.M., and the updating module 404 determines the acquired machine data at the same time 9:00 A.M.

The updating module 404 further updates the machine data file with the acquired machine data, in response to a determination that the acquired machine data is different from the machine data file.

The transferring module 405 periodically transfers the updated machine data file to the database system 50. In one embodiment, the transferring module 405 reads the updated machine data file and stores the updated machine data file to the database system 50.

The notification module 406 sends an alert notification to the user, in response to a determination that the application server 40 has not been connected to the data collector 30. In one embodiment, the notification module 406 sends an e-mail or a message to notify the user that the application server 40 has not been connected to the data collector 30.

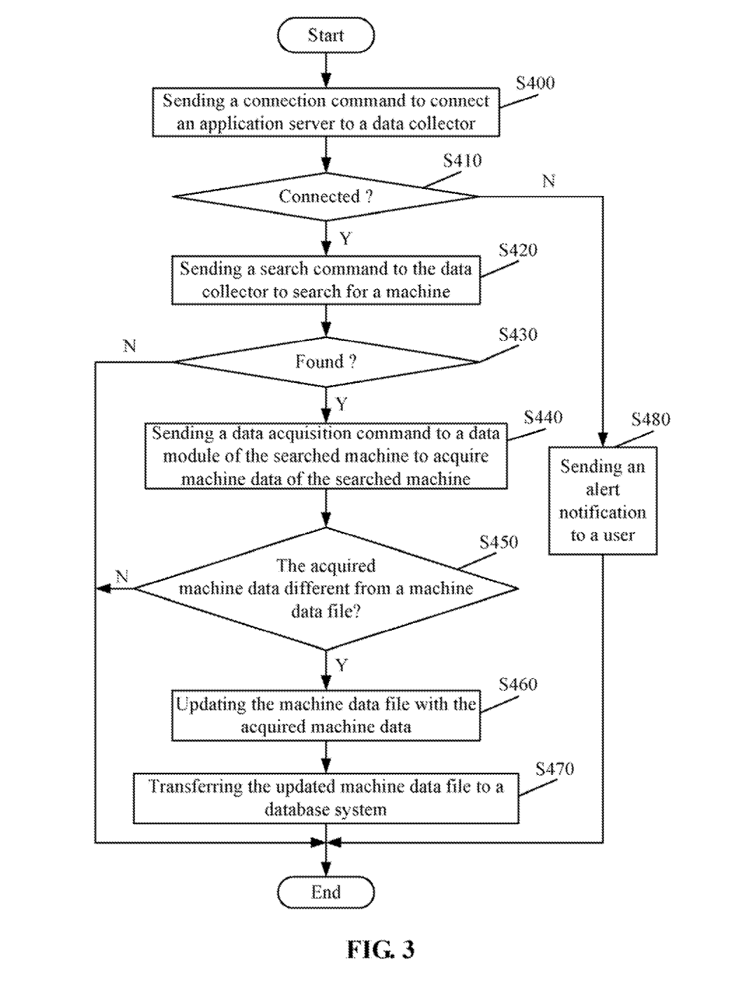

FIG. 3 is a flowchart of one embodiment of a method for collecting machine data. Depending on the embodiment, additional blocks may be added, others deleted, and the ordering of the blocks may be changed.

In block S400, the sending module 401 sends a connection command to electronically connect the application server 40 to the data collector 30. As mentioned above, the application server 30 establishes a communication connection with the data collector 30 using the connection command.

In block S410, the search module 402 determines if the application server 40 has been electronically connected to the data collector 30. The procedure goes to block S420 if the application server 40 has been connected to the data collector 30. The procedure goes to block S480 if the application server 40 has not been connected to the data collector 30. In block S480, the notification module 406 sends an alert notification to a user. In one embodiment, the notification module 406 sends the alert notification so that the user may be aware of problems quickly and easily. The alert notification may be an e-mail or a message. The e-mail or the message may include information “Error: the application server has not been connected to the data collector.” in one example.

In block S420, the search module 402 sends a search command to the data collector 30 to search one of the machines 10. For example, if the search command includes the machine name A, and the search command is used to search the machine A.

In block S430, the obtaining module 403 further determines if the machine 10 has been found according to the search command. In one embodiment, if the machine A sends a feedback message to the collector 30, the procedure goes to block S440. The procedure ends if the machine A does not send the feedback message to the data collector 30.

In block S440, the obtaining module 403 sends a data acquisition command to the sensor 10 to acquire machine data of the searched machine 10. For example, the obtaining module 403 sends the data acquisition command to the sensor A, and the sensor A automatically acquires the machine data of the machine A.

In block S450, the updating module 404 determines if the acquired machine data is different from the machine data file stored in the storage system 42 of the application server 40. If the machine data file is different from the machine data file, the procedure goes to block S460. If the machine data file is the same with the machine data file, the procedure ends.

In block S460, the updating module 404 updates the machine data file with the acquired machine data.

In block S470, the transferring module 405 transfers the updated machine data file to the database system 50. As mentioned above, the transferring module 405 reads the updated machine data file and stores the updated machine data into the database system 50. In one embodiment, a user may set a scheduled time for starting a program for transferring the updated machine data file to the database system 50. For example, the user may set the time for starting the program at 9:00 A.M. If the current time is 9:00 A.M., the program for transferring the updated machine data file is executed.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An application server, comprising:
a storage system storing a machine data file;
at least one processor; and
a data collection unit stored in the storage system and being executable by the at least one processor, the data collection unit comprising:
a sending module operable to send a connection command to electronically connect the application server to a data collector;
a search module operable to send a search command to the data collector to search for a machine being electronically connected to the data collector in response to a determination that the application server is electronically connected to the data collector;
an obtaining module operable to send a data acquisition command to a sensor of the searched machine to acquire machine data of the searched machine, in response to a determination that the searched machine has been found;
an updating module operable to update the machine data file with the acquired machine data, in response to a determination that the acquired machine data is different from the machine data file; and
a transferring module operable to transfer the updated machine data file to a database system.

2. The system of claim 1, the data collection unit further comprises a notification module operable to send an alert notification to a user, in response to a determination that the application server has not been connected to the data collector.

3. The system of claim 1, wherein the application server is connected to the data collector upon the condition that an acknowledgement message from the data collector is received by the application server.

4. The system of claim 1, wherein the searched machine has been found upon the condition that a feedback message from the searched machine is received by the data collector.

5. The system of claim 1, wherein the machine data comprise a power consumption of the machine, a number of products being produced by the machine, a status of the machine, and a utilization rate of the machine.

6. The system of claim 1, wherein the machine data file is a TXT file, a WORD file, and an EXCEL file.

7. A computer-based method for collecting machine data, the method comprising:
sending a connection command to electronically connect an application server to a data collector;
sending a search command to the data collector to search for a machine being electronically connected to the data collector in response to a determination that the application server is electronically connected to the data collector;
sending a data acquisition command to a sensor of the searched machine to acquire the machine data of the searched machine, in response to a determination that the searched machine has been found;
updating a machine data file with the acquired machine data, in response to a determination that the acquired machine data is different from the machine data file; and
transferring the updated machine data file to a database system.

8. The method of claim 7, further comprising sending an alert notification to a user, in response to a determination that the application server is not connected to the data collector.

9. The method of claim 7, wherein the application server is connected to the data collector upon the condition that an acknowledgement message from the data collector is received by the application server.

10. The method of claim 7, wherein the searched machine has been found upon the condition that a feedback message from the searched machine is received by the data collector.

11. The method of claim 7, wherein the machine data comprise a power consumption of the machine, a number of products being produced by the machine, a status of the machine, and a utilization rate of the machine.

12. The method of claim 7, wherein the machine data file is a TXT file, a WORD file and an EXCEL file.

13. A computer-readable medium having stored thereon instructions that, when executed by a computing device, causing the computing device to perform a data collection method, the method comprising:
sending a connection command to electronically connect an application server to a data collector;
sending a search command to the data collector to search for a machine being electronically connected to the data collector in response to a determination that the application server is electronically connected to the data collector;
sending a data acquisition command to a sensor of the searched machine to acquire the machine data of the searched machine, in response to a determination that the searched machine has been found;
updating a machine data file with the acquired machine data, in response to a determination that the acquired machine data is different from the machine data file; and
transferring the updated machine data file to a database system.

14. The medium of claim 13, further comprising the method of sending an alert notification to a user, in response to a determination that the application server has not been connected to the data collector.

15. The medium of claim 13, wherein the application server is connected to the data collector upon the condition that an acknowledgement message from the data collector is received by the application server.

16. The medium of claim 13, wherein the searched machine has been found upon the condition that a feedback message from the searched machine is received by the data collector.

17. The medium of claim 13, wherein the machine data comprise a power consumption of the machine, a number of products being produced by the machine, a status of the machine, and a utilization rate of the machine.

18. The medium of claim 13, wherein the machine data file is a TXT file, a WORD file, and an EXCEL file.
